(19) United States
(12) Patent Application Publication
(10) Pub. No.: US 2015/0268850 A1
(43) Pub. Date: Sep. 24, 2015

(54) Method of Implementing Screen Adaptation for Owner-Drawn Elements and Apparatus

(71) Applicant: TENCENT TECHNOLOGY (SHENZHEN) COMPANY LIMITED, Shenzhen (CN)

(72) Inventors: Jianqiang Zhang, Shenzhen (CN); Chunhua Luo, Shenzhen (CN); Yu Tian, Shenzhen (CN); Cheng Guo, Shenzhen (CN); Zhiqiang He, Shenzhen (CN)

(21) Appl. No.: 14/732,967

(22) Filed: Jun. 8, 2015

Related U.S. Application Data
(63) Continuation of application No. PCT/CN2013/089929, filed on Dec. 19, 2013.

(30) Foreign Application Priority Data
Dec. 19, 2012 (CN) 201210553224.6

(51) Int. Cl. G06F 3/0484

(52) U.S. Cl. CPC G06F 3/04847; G06F 3/04842

(57) ABSTRACT

A method of implementing screen adaptation for an owner-drawn element and a corresponding apparatus are provided. In the method, at least one owner-drawn element is arranged, and a first view adapted to the initial screen is obtained. Then, determine an adaptation interface of the first interface according to a resolution of a target screen, and define a corresponding container for each owner-drawn element arranged on the first interface. Obtain at least one margin of each owner-drawn element relative to a corresponding container, and set the attribute of the at least one margin as a fixed margin or a zoomed margin. Zoom the first interface according to the size of the adaptation interface, and adjust the owner-drawn element arranged on the first interface according to the margin attributes of the owner-drawn element relative to its corresponding container, in order to obtain a second view.

### CROSS-REFERENCE TO RELATED APPLICATIONS

This application is a continuation of International Application No. PCT/CN2013/089929, filed on Dec. 19, 2013, entitled “METHOD OF IMPLEMENTING SCREEN ADAPTATION FOR OWNER-DRAWN ELEMENTS AND APPARATUS”, which claims priority to the Chinese Patent Application No. 201210553224.6, filed on Dec. 19, 2012, the disclosure of each application is hereby incorporated in its entirety by reference.

### TECHNICAL FIELD

The present invention relates to computer technologies, and specifically to a method of implementing screen adaptation for owner-drawn elements and a corresponding apparatus.

### BACKGROUND

At present, networks such as a telecommunications network, a computer network and a cable television network can provide communication services that include integrated multimedia such as voice, data, image, etc. Also, more and more application products regarding the communication services are required to support various types of networks and terminals. For example, the products need to be applicable on such as PCs, mobile terminals, televisions, and set-top boxes. Accordingly, the products also need to accommodate different resolutions of display screens of these devices. That is to say, the products need to adapt to different terminal screens.

Generally, when developing an application product, developers may face different screen resolutions of various terminals, and consume a significant amount of time, even developing a separate version for a certain resolution, to provide adaptation to all screen resolutions for a certain platform. The large amount of repeated workload may lead to inefficiency of development. Although user interface (UI) controls officially provided for an operating system of some device can support automatic arrangement at multiple resolutions, these application programming interfaces (APIs) are mostly for simple application development. The APIs are poorly suited for certain complex scenes (such as a game) and scenes defined by the developers.

In view of the situation, when the developers develop terminal applications for the terminal devices, in addition to using a UI control included in a software development kit (SDK) officially provided, a set of owner-drawn elements may be packaged depending on features and language types of the terminal devices to facilitate terminal application development. The owner-drawn element library may completely replace the associated UI controls provided in the official SDK during the development. Its functions may be expanded freely, and it can be developed with more flexibility and implemented easily in different platforms. A typical frame structure of such owner-drawn element library is shown in FIG. 1.

In a terminal device adopting IOS as an operating system, because of its fixed screen resolution of 3:2 (e.g., iPhone3GS has a resolution of 320*480, and iPhone4 has a resolution of 640*960), an application program for owner-drawn elements may be employed in the terminal device for stretching or compressing the owner-drawn elements within an owner-drawn area to change their sizes according to a ratio, and also adjusting the coordinate based on the ratio, in order to achieve a perfect screen adaptation. However, as to terminal devices using an Android operating system, due to their unified screen resolution ratios, it cannot simply rely on proportional calculation to implement screen adaptation for the owner-drawn elements. It is necessary to calculate the owner-drawn elements with different positions, different uses and different attributes, respectively, during an encoding process, according to actual requirements, in order to provide screen adaptation for the owner-drawn elements in a variety of resolutions.

### SUMMARY

In an example, a method of implementing screen adaptation for owner-drawn elements includes: arranging at least one owner-drawn element according to a resolution of an initial screen, and obtaining a first view adapted to the initial screen, wherein the first view includes a first interface and the at least one owner-drawn element arranged on the first interface; determining an adaptation interface of the first interface according to a resolution of a target screen; defining a corresponding container for each owner-drawn element arranged on the first interface, wherein the first interface is defined as a container of one of the at least one owner-drawn element arranged on the first interface; obtaining at least one margin of each owner-drawn element relative to a corresponding container, and setting the attribute of the at least one margin as a fixed margin or a zoomed margin, wherein the margin with the attribute of fixed margin is kept constant, and the margin with the attribute of zoomed margin changes with the zooming of the corresponding container; zooming the first interface according to the size of the adaptation interface, and adjusting the owner-drawn element arranged on the first interface according to the margin attributes of the owner-drawn element relative to its corresponding container, in order to obtain a second view; drawing the second view on the target screen.

In an example, a method of implementing screen adaptation for owner-drawn elements includes: arranging at least one owner-drawn element according to a resolution of an initial screen, and obtaining a first view adapted to the initial screen, wherein the first view includes a first interface and the at least one owner-drawn element arranged on the first interface; determining an adaptation interface of the first interface according to a resolution of a target screen; obtaining an interface pretreatment proportion according to the resolution of the target screen and the resolution of the initial screen, and zooming the first interface and the at least one owner-drawn element of the first view according to the interface pretreatment proportion to get a second view, wherein the second view includes a second interface and owner-drawn elements arranged on the second interface; defining a corresponding container for each owner-drawn element arranged on the second interface, wherein the second interface is defined as a container of one of the at least one owner-drawn element arranged on the first interface; obtaining at least one margin of each owner-drawn element relative to a corresponding container, and setting the attribute of the at least one margin as a fixed margin or a zoomed margin, wherein the margin with the attribute of fixed margin is kept constant, and the margin with the attribute of zoomed margin changes with the zooming of the corresponding container; zooming the second interface according to the size of the adaptation interface, and adjusting the owner-drawn element arranged on the second interface according to the margin attributes of the owner-drawn element relative to its corresponding container, in order to obtain a third view; drawing the third view on the target screen.

In an example, an apparatus of implementing screen adaptation for owner-drawn elements includes: an initial arrangement module, to arrange at least one owner-drawn element according to a resolution of an initial screen, and obtain a first view adapted to the initial screen, wherein the first view includes a first interface and the at least one owner-drawn element arranged on the first interface; a target determination module, to determine an adaptation interface of the first interface according to a resolution of a target screen; a zoom module, to define a corresponding container for each owner-drawn element arranged on the first interface, wherein the first interface is defined as a container of one of the at least one owner-drawn element arranged on the first interface, and obtain at least one margin of each owner-drawn element relative to a corresponding container, and set the attribute of the at least one margin as a fixed margin or a zoomed margin, wherein the margin with the attribute of fixed margin is kept constant, and the margin with the attribute of zoomed margin changes with the zooming of the corresponding container; an adjustment module, to zoom the first interface according to the size of the adaptation interface, and adjust the owner-drawn element arranged on the first interface according to the margin attributes of the owner-drawn element relative to its corresponding container, in order to obtain a second view; and a drawing module, to draw the second view on the target screen.

In an example, an apparatus of implementing screen adaptation for owner-drawn elements includes: an initial arrangement module, to arrange at least one owner-drawn element according to a resolution of an initial screen, and obtain a first view adapted to the initial screen, wherein the first view includes a first interface and the at least one owner-drawn element arranged on the first interface; a target determination module, to determine an adaptation interface of the first interface according to a resolution of a target screen; a pretreatment module, to obtain an interface pretreatment proportion according to the resolution of the target screen and the resolution of the initial screen, and zoom the first interface and the at least one owner-drawn element of the first view according to the interface pretreatment proportion to get a second view, wherein the second view includes a second interface and owner-drawn elements arranged on the second interface; a zoom module, to define a corresponding container for each owner-drawn element arranged on the second interface, wherein the second interface is defined as a container of one of the at least one owner-drawn element arranged on the first interface, obtain at least one margin of each owner-drawn element relative to a corresponding container, and set the attribute of the at least one margin as a fixed margin or a zoomed margin, wherein the margin with the attribute of fixed margin is kept constant, and the margin with the attribute of zoomed margin changes with the zooming of the corresponding container; an adjustment module, to zoom the second interface according to the size of the adaptation interface, and adjust the owner-drawn element arranged on the second interface according to the margin attributes of the owner-drawn element relative to its corresponding container, in order to obtain a third view; and a drawing module, to draw the third view on the target screen.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 shows a typical frame structure of an owner-drawn element library in traditional art.

FIG. 2 is a flow diagram of a method of implementing screen adaptation for an owner-drawn element in accordance with an embodiment of the present invention.

FIG. 3 is a schematic diagram illustrating a comparison among an initial screen, a first view, and a target screen in accordance with the embodiment shown in FIG. 2 of the present invention.

FIG. 4 illustrates margins of an owner-drawn element relative to a container.

FIG. 5 is a schematic diagram illustrating a comparison between size and position of both owner-drawn element A1 and owner-drawn element A2 comparing to container B before the size changing of container B and those after the size changing of container B.

FIG. 6 is a flow diagram illustrating step S14 described in FIG. 2.

FIG. 7 illustrates an effect after mapping a second view on a target screen according to the embodiment shown in FIG. 2 of the present invention.

FIG. 8 is a flow diagram of a method of implementing screen adaptation for an owner-drawn element in accordance with an embodiment of the present invention.

FIG. 9 is a schematic diagram illustrating a comparison of an initial screen and a target screen in accordance with the embodiment shown in FIG. 8 of the present invention.

FIG. 10 shows a complete effect after mapping a second view on a target screen in accordance with the embodiment shown in FIG. 8 of the present invention.

FIG. 11 is a flow diagram illustrating a method of implementing screen adaptation for an owner-drawn element in accordance with an embodiment of the present invention.

FIG. 12 is a schematic diagram illustrating a comparison of an initial screen and a target screen in accordance with the embodiment shown in FIG. 11 of the present invention.

FIG. 13 illustrates a comparative effect between a second view and a target screen after interface pretreatment in accordance with the embodiment shown in FIG. 11 of the present invention.

FIG. 14 illustrates an effect after mapping a third view into a target screen in accordance with the embodiment shown in FIG. 11 of the present invention.

FIG. 15 is a flow diagram illustrating a method of implementing screen adaptation for an owner-drawn element in accordance with an embodiment of the present invention.

FIG. 16 is a schematic diagram illustrating a comparison of an initial screen and a target screen in accordance with the embodiment shown in FIG. 15 of the present invention.

FIG. 17 presents a comparative effect of a second view with a target screen after interface pretreatment in accordance with the embodiment shown in FIG. 15 of the present invention.

FIG. 18 shows an effect after mapping a third view on a target screen according to the embodiment shown in FIG. 15 of the present invention.

FIG. 19 is a structure diagram illustrating an apparatus of implementing screen adaptation for an owner-drawn element in accordance with an embodiment of the present invention.

FIG. 20 is a structure diagram illustrating an apparatus of implementing screen adaptation for an owner-drawn element in accordance with an embodiment of the present invention.

FIG. 21 is a structure diagram illustrating an apparatus of implementing screen adaptation for an owner-drawn element in accordance with an embodiment of the present invention.

FIG. 22 is a structure diagram illustrating an apparatus of implementing screen adaptation for an owner-drawn element in accordance with an embodiment of the present invention.

FIG. 23 is a block diagram illustrating a computing device in accordance with an embodiment of the present disclosure.

### DETAILED DESCRIPTION

Reference will now be made in detail to examples, which are illustrated in the accompanying drawings. In the following detailed description, numerous specific details are set forth in order to provide a thorough understanding of the present disclosure. Also, the figures are illustrations of an example, in which modules or procedures shown in the figures are not necessarily essential for implementing the present disclosure. In other instances, well-known methods, processes, procedures, structures, components, and circuits have not been described in detail so as not to unnecessarily obscure aspects of the examples.

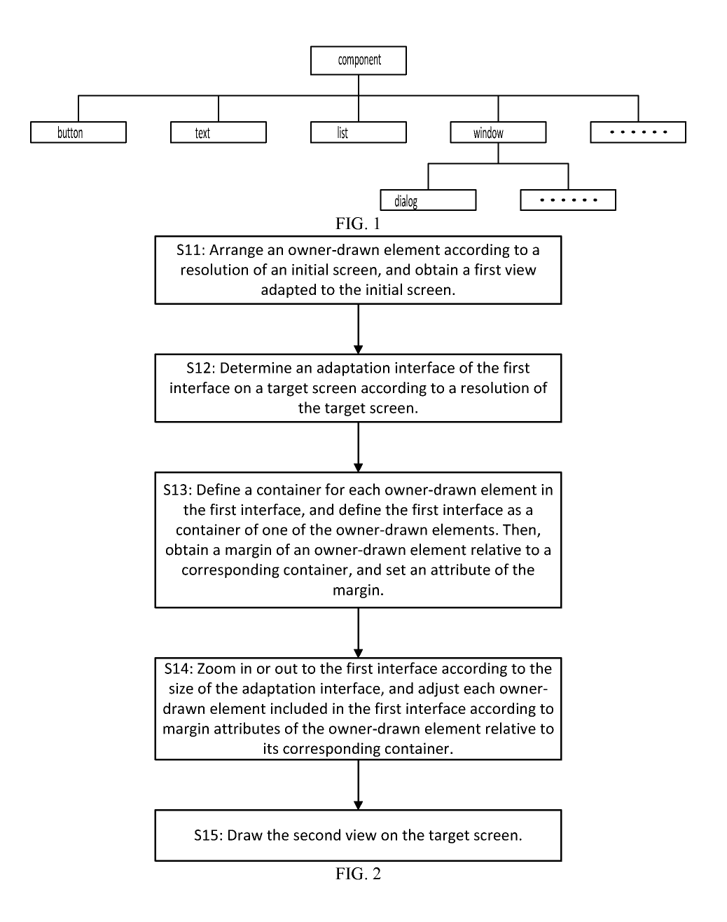

FIG. 2 is a flow diagram of a method of implementing screen adaptation for an owner-drawn element in accordance with an embodiment of the present invention. Referring to FIG. 2, the method of implementing screen adaptation for the owner-drawn element provided in this embodiment includes the following procedures.

Step S11: Arrange the owner-drawn element according to a resolution of an initial screen, and obtain a first view adapted to the initial screen. In an example, the first view includes a first interface, and also includes the owner-drawn element arranged within the first interface.

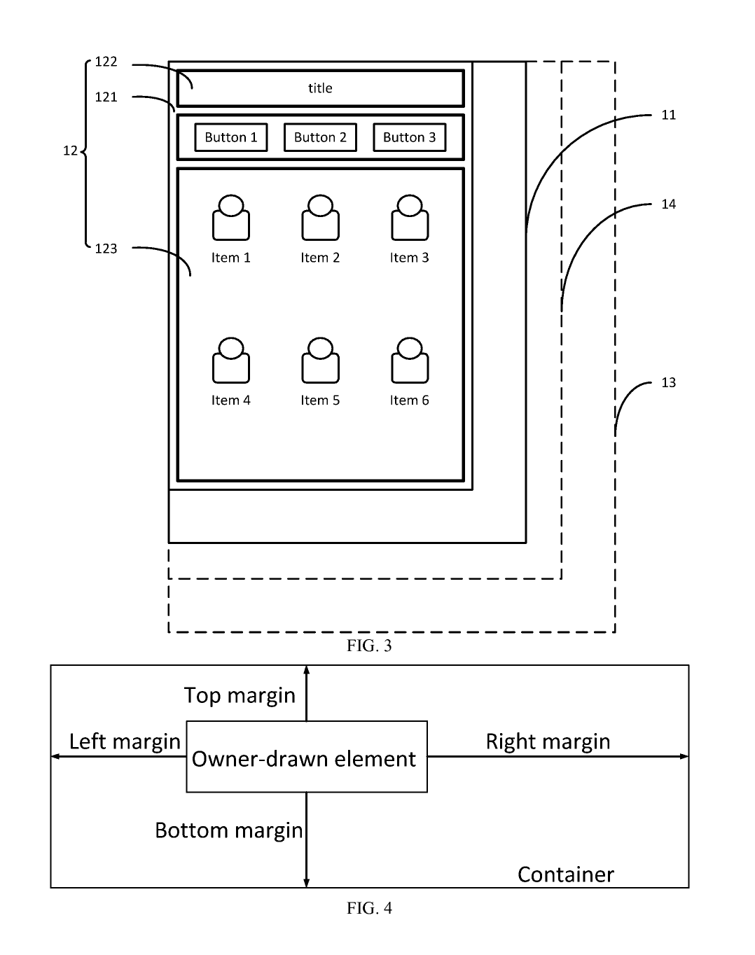

A screen resolution is the number of pixels that may be displayed on the screen. For example, the screen resolution of 480*800 means that the width is 480 pixels and the height is 800 pixels. Also referring to FIG. 3, at step S11, each owner-drawn element is arranged based on the resolution of the initial screen 11 (or a design draft), to obtain the first view 12 adapted to the initial screen 11. The first view 12 may include the first interface 121 and a plurality of owner-drawn elements 122 arranged on the first interface 121. In FIG. 3, the owner-drawn elements 122 may, for example, include: a title bar (named title) of the interface, three buttons (named button) of the interface, and six items (named item) in a display region 123. Of course, it is not required to limit the invention within a specific arrange of the owner-drawn elements. All owner-drawn elements 122 in the first view 12 are without any coordinate and size conversion, which are able to perfectly adapt to a terminal screen having the same resolution as the initial screen 11.

Step S12: Determine an adaptation interface of the first interface on a target screen according to the resolution of the target screen.

Referring to FIG. 3, the target screen 13 shown in FIG. 3 is indicated by dotted lines. Before plotting an interface on the target screen 13, it is required to access the screen resolution of the target screen 13. In step S12, based on the resolution of the target screen 13, determine the size of the adaptation interface 14 on the target screen 13 corresponding to the first interface 121, i.e., the adaptation interface 14 is a perfect adaptation of the first interface 121 on the target screen 13. In an example, the first interface 121 may be stretched or compressed according to a ratio of the initial screen and the target screen, to obtain the adaptation interface 14.

Step S13: Define a container for each owner-drawn element in the first interface, and define the first interface as a container of one of the owner-drawn elements. Then, obtain a margin of an owner-drawn element relative to a corresponding container, and set an attribute of the margin. In an example, the margin may be a fixed margin or a zoomed margin, where a margin with an attribute of fixed margin is always kept constant, while a margin whose corresponding attribute is a zoomed margin changes with the zooming of a corresponding container.

Step S14: Zoom in or out to the first interface according to the size of the adaptation interface, and adjust each owner-drawn element included in the first interface according to margin attributes of the owner-drawn element relative to its corresponding container. In this way, a second view is obtained.

Steps S13 and S14 are a process of zooming in or out on the first interface and slightly adjusting the owner-drawn elements arranged on the first interface.

In an example, it is possible to define a container for each owner-drawn element (e.g., a component). For example, the first interface 121 may be defined as a container of a title bar in the first view 12, and the title bar may be defined as a container of a button in the first view 12. As such, the size and position of an owner-drawn element can be mapped into four margins in up, down, left, and right directions relative to its container, as shown in FIG. 4. Accordingly, when the size of the corresponding container changes, the size and position of the owner-drawn element may be determined after the change by controlling the four margins of the owner-drawn element.

Specifically, the four margins of the owner-drawn element relative to its container may be defined as a left margin (margin_left), a right margin (margin_right), a top margin (margin_top), and a bottom margin (margin_bottom), respectively. Accordingly, the position (x, y) of the owner-drawn element (e.g., a component) within the container is represented as (margin_left, margin_top), the width of the owner-drawn element is (container.width−margin_left−margin_right), and the height is (container.height−margin_top−margin_bottom). Meanwhile, the size and position of the owner-drawn element can be represented as (abscissa, ordinate, width, height).

The attributes of these four margins may be set separately. In an example, the margin attribute can be set as a fixed margin (margin_fix) or a zoomed margin (margin_zoom), respectively. The two types of attributes may be described below, respectively.

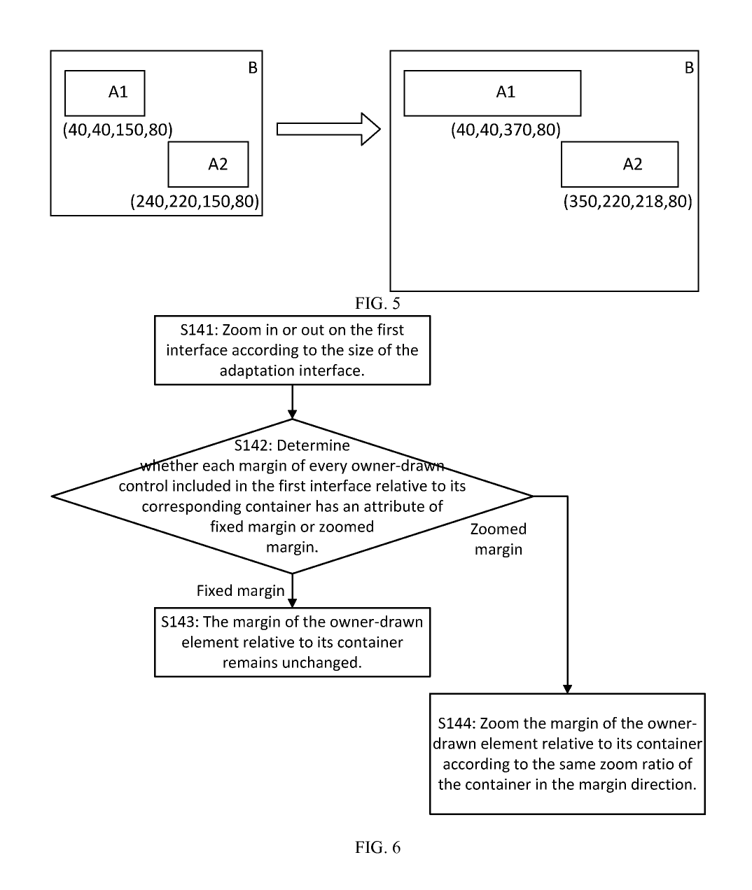

(1) As to the fixed margin (margin_fix), it means that the size of a margin of the owner-drawn element relative to its container is unchanged. For example, when the left margin and the right margin of the owner-drawn element have an attribute of margin_fix, no matter how the size of the container changes, the left and right margins of the owner-drawn element relative to the container remain the same. The width of the owner-drawn element is (container.width−margin_left−margin_right), where the container.width is a target width of the container. The height of the owner-drawn element is (container.height−margin_left−margin_right, where the container.height is a target height of the container. FIG. 5 is referred to in the following description, where the left part of FIG. 5 illustrates the size and position of owner-drawn element A1 and owner-drawn element A2 relative to container B prior to the change of the size of container B, while the right part of FIG. 5 shows the size and position of owner-drawn elements A1 and A2 relative to container B after the change of the size of container B. Take owner-drawn element A1 in FIG. 5 as an example, before the size change of container B, owner-drawn element A1 has a left margin of 40 (i.e., margin_left=40) and a right margin of 290 (margin_right=290), respectively. The attributes of margin_left and margin_right are set to margin_fix. When the width of container B is changed from 480 to 700, the left and right margins of owner-drawn element A1 relative to container B remain constant, while the width of owner-drawn element A1 changes to 370 which is calculated based on the formula: width=700−margin_left−margin_right=370, and the coordinate and size of owner-drawn element A1 is (40, 40, 370, 80).

(2) As to the zoomed margin (margin_zoom), it means a margin of the owner-drawn element may vary depending on the zooming of the corresponding container. Specifically, when the size of the container changes, a margin of the owner-drawn element with a zoomed margin attribute is equal to (the margin before change*the target size of the container/the original size of the container). Take owner-drawn element A2 in FIG. 5 as an example, the left margin and the right margin are set as margin_zoom, and before the size change of container B, the left and right margins of owner-drawn element A2 are margin_left=240 and margin_right=480-240−150=90, respectively. When the size of container B is changed, the left and right margins of owner-drawn element A2 relative to container B are margin_left=240*700/480=350 and margin_right=90*700/480=132, respectively. Therefore, the width of owner-drawn element A2 becomes (700−350−132=218), and the coordinate and size of owner-drawn element A2 becomes (380, 220, 218, 80).

Similarly, the top and bottom margins can also be provided with an attribute of fixed margin or zoomed margin, such that when the size of the container changes, the arrangement of the owner-drawn element may be adjusted with flexibility under the control of the margin attributes of the owner-drawn element, which causes a more coordinated and aesthetic arrangement of the owner-drawn element in the second view.

In steps S13 and S14, attributes of the four margins of the owner-drawn element relative to its corresponding container are set, and a processing may be carried out on a margin in terms of its attribute. In this way, the owner-drawn element may adjust the arrangement within its container. Meanwhile, the owner-drawn element can act as a container of another owner-drawn element. In the present embodiment, the first interface is defined as a container of one of the owner-drawn elements. Of course, the first interface may be designated as a container of another owner-drawn element. Also, the owner-drawn element having the first interface as its container may also act as a container of the other owner-drawn element. In an example, the first interface may be defined as all owner-drawn elements' container. In another example, the first interface may be defined as a container of one of the owner-drawn elements (such as a title bar), whereas the owner-drawn element (i.e., the title bar) is used as a container of the other owner-drawn element (such as a button). That is, the first interface is defined as a first layer container, the owner-drawn element (e.g., the title bar) is defined as a second level container, and a third layer container, a fourth layer container, or the like may be defined, if desired. As such, when the first layer container (i.e., the first interface) is changed in the size, the arrangement of each owner-drawn element can be adjusted according to its corresponding margin attributes. Then, by traversing each UI control, a process of screen adaptation can be achieved eventually for all the owner-drawn elements.

Specifically, as shown in FIG. 6, step S14 may include the following steps.

Step S141: Zoom in or out on the first interface according to the size of the adaptation interface.

Step S142: Determine whether each margin of every owner-drawn element included in the first interface relative to its corresponding container has an attribute of fixed margin or zoomed margin. If the margin is a fixed margin, proceed to step S143. If the margin is a zoomed margin, proceed to step S144.

Step S143: The margin of the owner-drawn element relative to its container remains unchanged. In an example, owner-drawn element A1 in FIG. 5 may be used as a reference for this step.

Step S144: Zoom the margin of the owner-drawn element relative to its container according to the same zoom ratio of the container in the margin direction. In an example, this step may be implemented with reference to owner-drawn element A2 in FIG. 5.

In an example, a “margin direction” is the same as the direction for measuring the margin. For example, left and right margins have a transverse direction, while top and bottom margins are in a longitudinal direction. Assume that the container has a zoom ratio of “a” in the transverse direction, then the zooming of the left and right margins of the owner-drawn element may be carried out according to the zoom ratio “a”. Assume that the container has a zoom ratio of “b” at a longitudinal direction, then the zooming of the top and bottom margins of the owner-drawn element may be executed according to the zoom ratio “b”.

Step S15: Draw the second view on the target screen, which is the final step of the process.

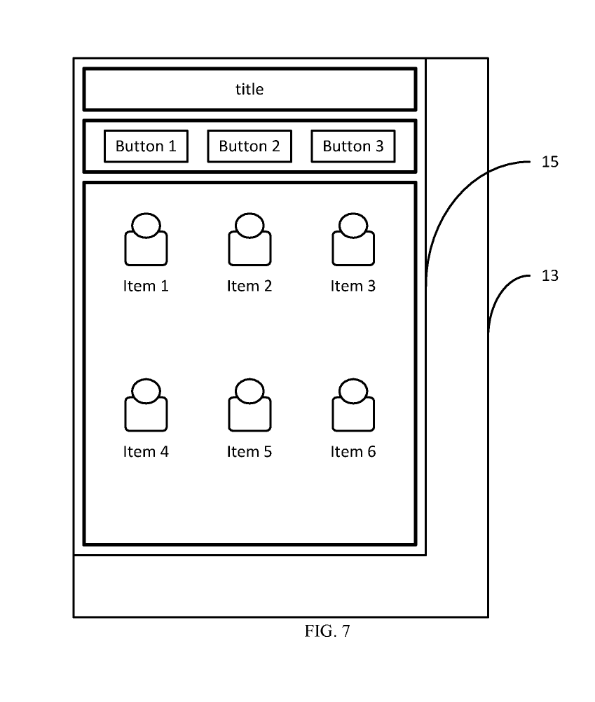

In an example, refer to FIG. 7, the second view is drawn on the target screen in a full-screen mode, ultimately achieving a perfect adaptation for a target terminal screen with a target screen resolution. Specifically, FIG. 7 shows an effect of drawing the second view 15 on the target screen 13.

Compared to the existing art, the method of implementing screen adaptation for the owner-drawn element proposed in the embodiments is simple and efficient by using an interface processing approach including an interface zoom and an adjustment of elements arrangement. Furthermore, the method may cause the arrangement of various owner-drawn elements of application software on the user interface (UI) more coordinated and beautiful. In addition, the method uses less raw UI resources, has small installation package, decreases the threshold of installation, simplifies code maintenance, provides a small coupling for various owner-drawn elements in a screen, and facilitates code maintenance.

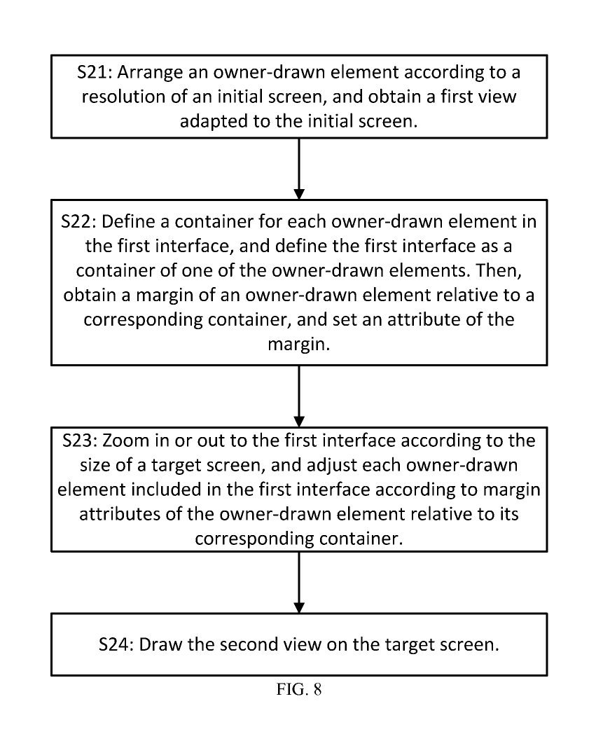

FIG. 8 is a flow diagram of a method of implementing screen adaptation for an owner-drawn element in accordance with an embodiment of the present invention. Referring to FIG. 8, the method of implementing screen adaptation for the owner-drawn element provided in this embodiment includes the following procedures.

Step S21: Arrange the owner-drawn element according to a resolution of an initial screen, and obtain a first view adapted to the initial screen. In an example, the first view includes a first interface, and also includes the owner-drawn element arranged within the first interface.

Step S22: Define a container for each owner-drawn element in the first interface, and define the first interface as a container of one of the owner-drawn elements. Then, obtain a margin of an owner-drawn element relative to a corresponding container, and set an attribute of the margin. In an example, the margin may be a fixed margin or a zoomed margin, where a margin with an attribute of fixed margin is always kept constant, while a margin whose corresponding attribute is a zoomed margin changes with the zooming of a corresponding container.

Step S23: Zoom in or out to the first interface according to the size of the target screen, and adjust each owner-drawn element included in the first interface according to margin attributes of the owner-drawn element relative to its corresponding container. In this way, a second view is obtained.

Step S24: Draw the second view on the target screen.

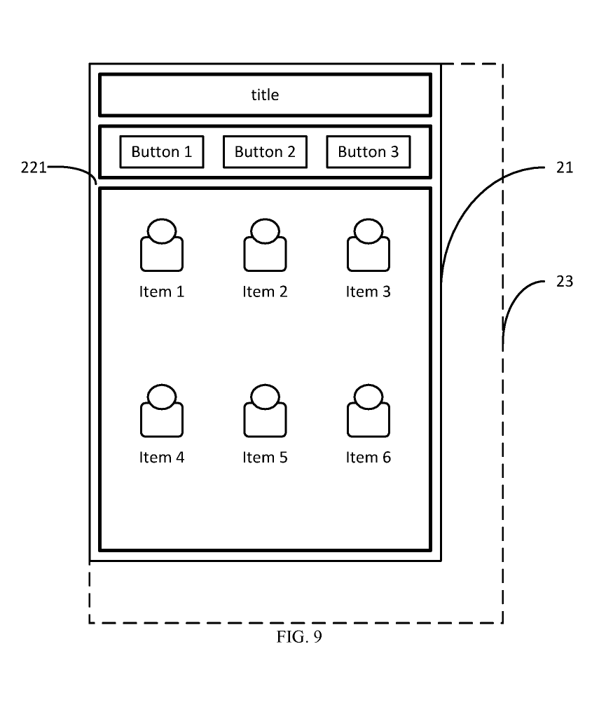

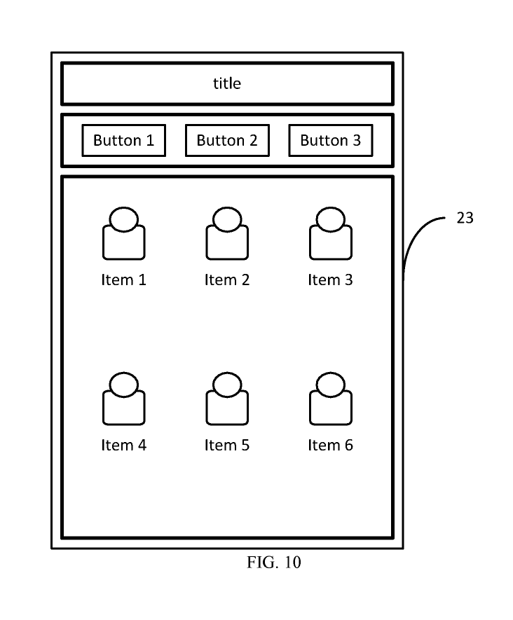

Referring also to FIGS. 9 and 10, unlike the embodiment shown in FIG. 2, in this embodiment, the first interface 221 has the same size as the initial screen 21. In other words, the first interface 221 spreads throughout the initial screen 21. Therefore, the adaptation interface of the first interface 221 has the same size as the target screen 23. Accordingly, step S12 in the embodiment shown in FIG. 2 may be omitted in this embodiment. In another example, in step S23, zoom the first interface 221 directly in terms of the size of the target screen 23, and adjust the owner-drawn elements in the first interface according to the margin attributes of the owner-drawn elements relative to their corresponding containers, thereby obtaining the second view. Other steps are the same as corresponding steps in the embodiment shown in FIG. 2, which may not be described in detail hereon. Referring to FIG. 10, the second view is finally drawn onto the target screen 23.

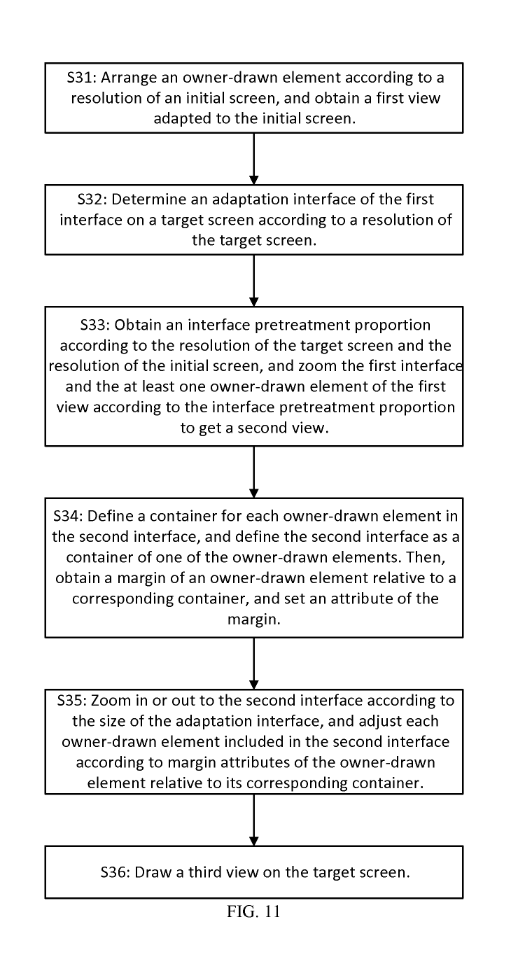

FIG. 11 is a flow diagram illustrating a method of implementing screen adaptation for an owner-drawn element in accordance with an embodiment of the present invention. Referring to FIG. 11, a method of implementing screen adaptation for owner-drawn elements in the embodiment includes the following steps.

S31: Arrange at least one owner-drawn element according to a resolution of an initial screen, and obtain a first view adapted to the initial screen. In an example, the first view includes a first interface and the at least one owner-drawn element arranged on the first interface.

S32: Determine an adaptation interface of the first interface according to a resolution of a target screen.

S33: Obtain an interface pretreatment proportion according to the resolution of the target screen and the resolution of the initial screen, and zoom the first interface and the at least one owner-drawn element of the first view according to the interface pretreatment proportion to get a second view, wherein the second view includes a second interface and owner-drawn elements arranged on the second interface.

At this step, the interface pretreatment proportion is used. In an example, a smaller value among a ratio of the lateral resolution of the target screen to the lateral resolution of the initial screen and a ratio of the longitudinal resolution of the target screen to the longitudinal resolution of the initial screen is selected as the interface pretreatment proportion.

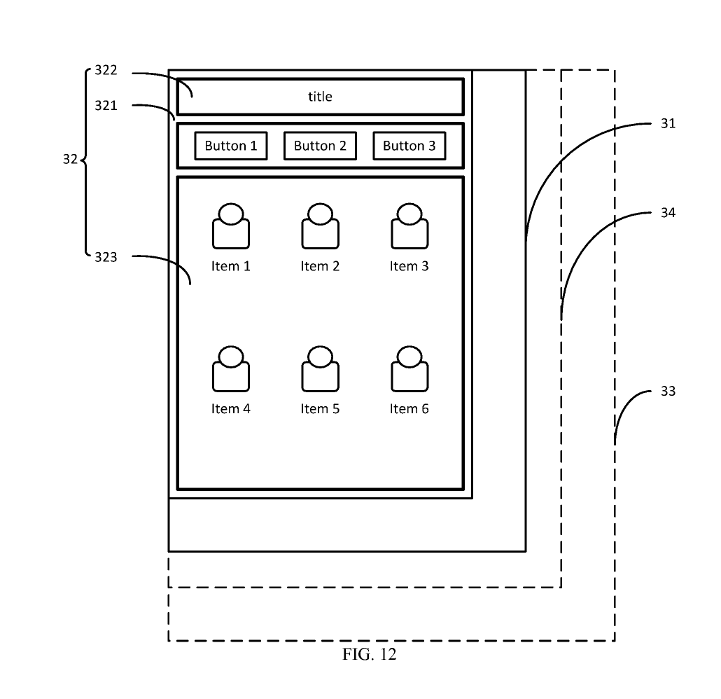

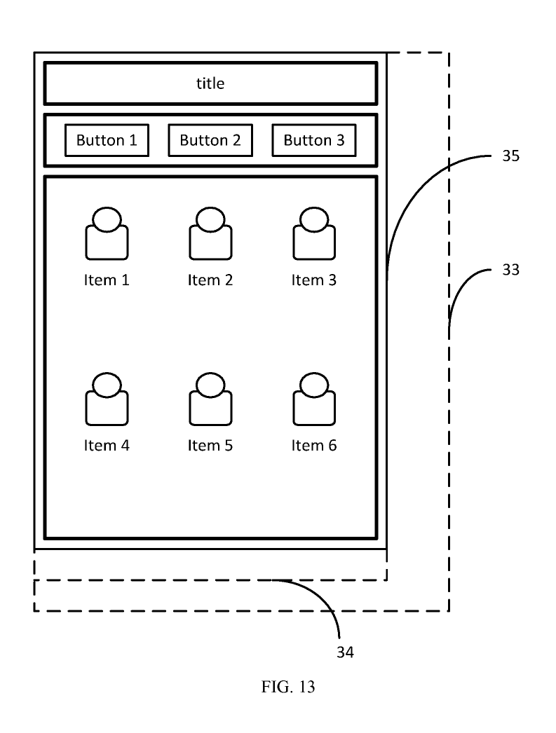

Refer also to FIG. 12. Each owner-drawn element is arranged according to the resolution of the initial screen 31 (or a design draft) in FIG. 12 to obtain the first view 32 adapted to the initial screen 31. The first view 32 includes the first interface 321 and a plurality of owner-drawn elements 322 arranged on the first interface 321. In FIG. 7, owner-drawn elements including a title bar (title), three buttons (button) and six items (item) are taken as an example. All owner-drawn elements 322 in the first view 32 have no coordinate and size conversion, and can perfectly adapt to a terminal screen with the initial screen resolution. In an example, the initial screen 31 has a lateral resolution (width) of w pixels, and also has a longitudinal resolution (height) of h pixels. FIG. 12 also includes a target screen 33, represented by dashed lines. Before drawing an interface on the target screen 33, it is required to get the resolution of the target screen 33. For example, in FIG. 12, the target screen 33 has a lateral resolution (width) of W pixels, and a longitudinal resolution (height) of H pixels. In step S32, the size of the adaptation interface 34 on the target screen 33 corresponding to the first interface 321 may be determined according to the resolution of the target screen 33. In an example, the size may be a size of the adaptation interface 34 on the target screen 13 that perfectly adapts to the first interface 121. In an example, the interface pretreatment proportion f is equal to min(target screen transverse resolution W/initial screen transverse resolution w, target screen longitudinal resolution H/initial screen longitudinal resolution h). That is, a smaller value may be picked out from a width ratio of the target screen to the initial screen, and a height ratio of the target screen to the initial screen. As such, during a pretreatment process, the view after the processing can meet the requirements of screen adaptation in the transverse or longitudinal direction. For example, suppose the target screen resolution is 480*854 and the initial screen resolution is 320*480, then the interface pretreatment proportion f=min(480/320, 854/480)=1.5. Specifically, FIG. 13 shows a comparative effect between the second view 35 and the target screen 33 obtained after interface pretreatment.

S34: Define a corresponding container for each owner-drawn element arranged on the second interface. In an example, the second interface is defined as a container of one of the at least one owner-drawn element arranged on the first interface. Obtain at least one margin of each owner-drawn element relative to a corresponding container, and set the attribute of the at least one margin as a fixed margin or a zoomed margin. In an example, the margin with the attribute of fixed margin is kept constant, and the margin with the attribute of zoomed margin changes with the zooming of the corresponding container.

S35: Zoom the second interface according to the size of the adaptation interface, and adjust the owner-drawn element arranged on the second interface according to the margin attributes of the owner-drawn element relative to its corresponding container, in order to obtain a third view.

S36: Draw the third view on the target screen.

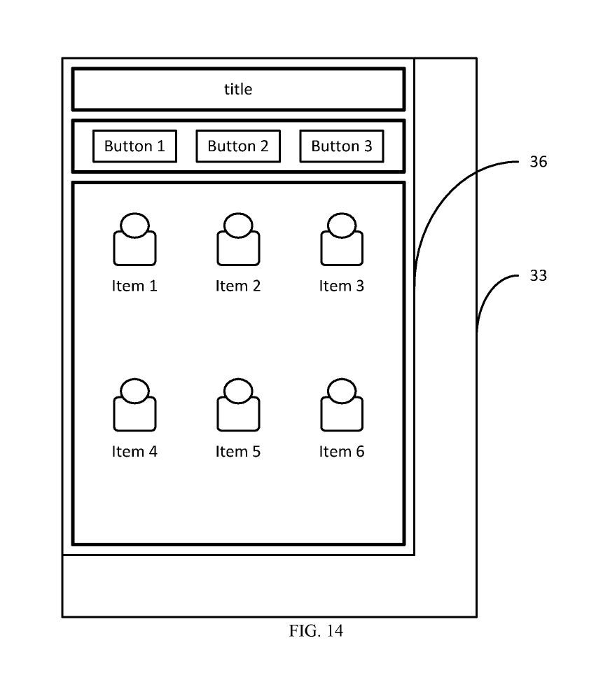

FIG. 14 is referred to hereon, which illustrates an effect after mapping a third view 36 into a target screen 33 in accordance with the embodiment shown in FIG. 8 of the present invention.

Compared to the existing art, in the method of implementing screen adaptation for the owner-drawn elements proposed in the embodiment, before the arrangement adjustment for the elements, a pretreatment step for the first view is added. Then, after the pretreatment, the processed view could as far as possible meet the requirements of screen adaptation in the transverse or longitudinal direction. In this way, there may be a better effect of adaptation on the one hand, and the adaptation speed may be accelerated on the other hand. In particular, the embodiment is suitable for the circumstance that the initial screen and the target screen have widely different resolutions.

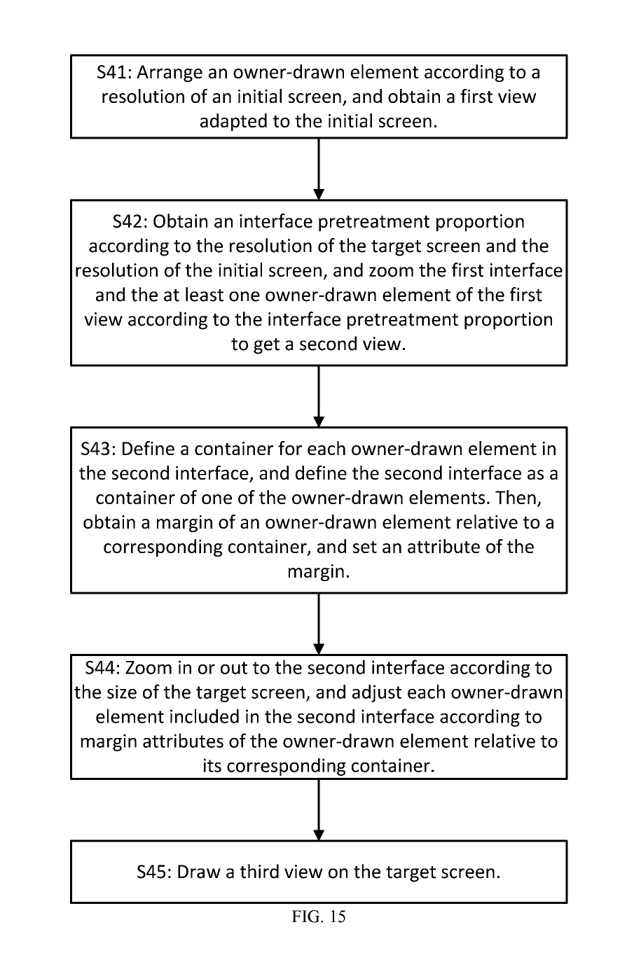

FIG. 15 is a flow diagram illustrating a method of implementing screen adaptation for an owner-drawn element in accordance with an embodiment of the present invention. Referring to FIG. 15, a method of implementing screen adaptation for owner-drawn elements in the embodiment includes the following steps.

Step S41: Arrange at least one owner-drawn element according to a resolution of an initial screen, and obtain a first view adapted to the initial screen. In an example, the first view includes a first interface and the at least one owner-drawn element arranged on the first interface.

Step S42: Obtain an interface pretreatment proportion according to the resolution of the target screen and the resolution of the initial screen, and zoom the first interface and the at least one owner-drawn element of the first view according to the interface pretreatment proportion to get a second view, wherein the second view includes a second interface and owner-drawn elements arranged on the second interface.

Step S43: Define a corresponding container for each owner-drawn element arranged on the second interface. In an example, the second interface is defined as a container of one of the at least one owner-drawn element arranged on the first interface. Obtain at least one margin of each owner-drawn element relative to a corresponding container, and set the attribute of the at least one margin as a fixed margin or a zoomed margin. In an example, the margin with the attribute of fixed margin is kept constant, and the margin with the attribute of zoomed margin changes with the zooming of the corresponding container.

Step S44: Zoom the second interface according to the size of the target screen, and adjust the owner-drawn element arranged on the second interface according to the margin attributes of the owner-drawn element relative to its corresponding container, in order to obtain a third view.

Step S45: Draw the third view on the target screen.

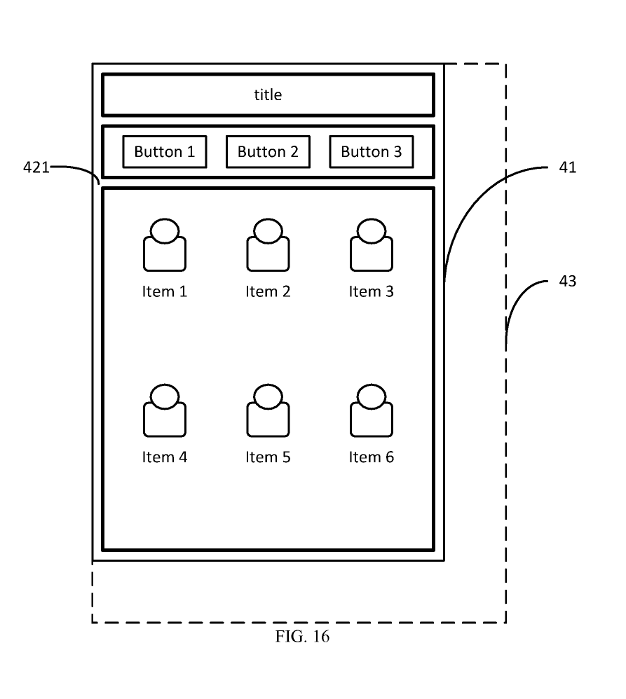

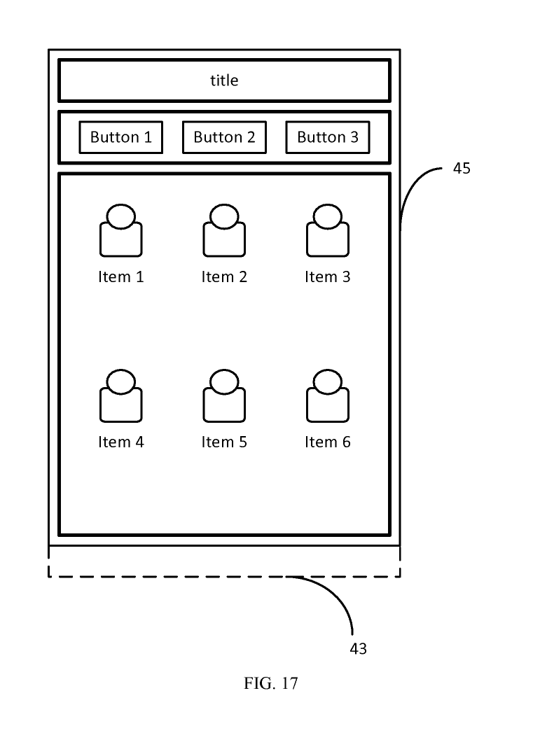

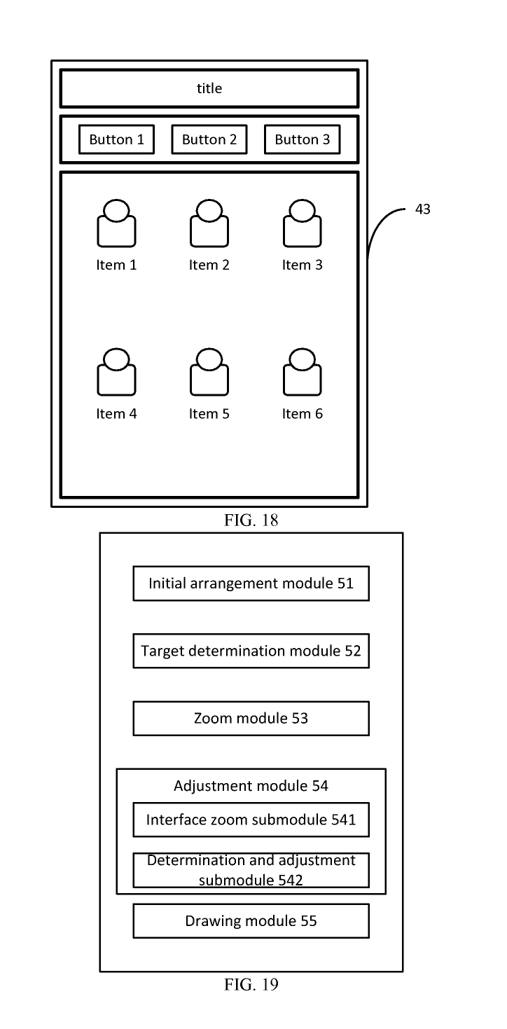

Referring also to FIGS. 16 to 18, unlike the embodiment shown in FIG. 11, in this embodiment, the first interface 421 has the same size as the initial screen 41. In other words, the first interface 421 spreads throughout the initial screen 41 (please refer to FIG. 16). Therefore, the adaptation interface of the first interface 421 has the same size as the target screen 43. Accordingly, step S32 in the embodiment shown in FIG. 11 may be omitted in this embodiment. FIG. 17 presents a comparative effect of the second view 45 with the target screen 43 after interface pretreatment in accordance with the embodiment shown in FIG. 15 of the present invention. That is, in step S44, zoom the second interface directly in terms of the size of the target screen, and adjust the owner-drawn elements in the second interface according to the margin attributes of the owner-drawn elements relative to their corresponding containers, thereby obtaining the third view. Other steps are the same as corresponding steps in the embodiment shown in FIG. 11, which may not be described in detail hereon. Referring to FIG. 18, the third view is finally drawn onto the target screen 43.

FIG. 19 is a structure diagram illustrating an apparatus of implementing screen adaptation for an owner-drawn element in accordance with an embodiment of the present invention. Referring to FIG. 19, an apparatus of implementing screen adaptation for owner-drawn elements proposed in this embodiment may be used to realize the method mentioned in such as the embodiment shown in FIG. 2. In an example, the apparatus includes: an initial arrangement module 51, a target determination module 52, a zoom module 53, an adjustment module 54, and a drawing module 55.

The initial arrangement module 51 is to arrange at least one owner-drawn element according to a resolution of an initial screen, and obtain a first view adapted to the initial screen, wherein the first view includes a first interface and the at least one owner-drawn element arranged on the first interface. The target determination module 52 is to determine an adaptation interface of the first interface according to a resolution of a target screen. The zoom module 53 is to define a corresponding container for each owner-drawn element arranged on the first interface, wherein the first interface is defined as a container of one of the at least one owner-drawn element arranged on the first interface, and obtain at least one margin of each owner-drawn element relative to a corresponding container, and set the attribute of the at least one margin as a fixed margin or a zoomed margin, wherein the margin with the attribute of fixed margin is kept constant, and the margin with the attribute of zoomed margin changes with the zooming of the corresponding container. The adjustment module 54 is to zoom the first interface according to the size of the adaptation interface, and adjust the owner-drawn element arranged on the first interface according to the margin attributes of the owner-drawn element relative to its corresponding container, in order to obtain a second view. The drawing module 55 is to draw the second view on the target screen.

In an example, the adjustment module 54 includes: an interface zoom submodule 541, and a determination and adjustment submodule 542.

The interface zoom submodule 541 is to zoom the first interface according to the size of the adaptation interface.

The determination and adjustment submodule 542 is to determine whether the owner-drawn element arranged on the first interface has a fixed margin attribute or zoomed margin attribute relative to its corresponding container, if the margin is the fixed margin, remain the margin of the owner-drawn element relative to its container unchanged; and if the margin is the zoomed margin, zoom the margin of the owner-drawn element relative to its container in the same zoom ratio as the container at the direction of the margin.

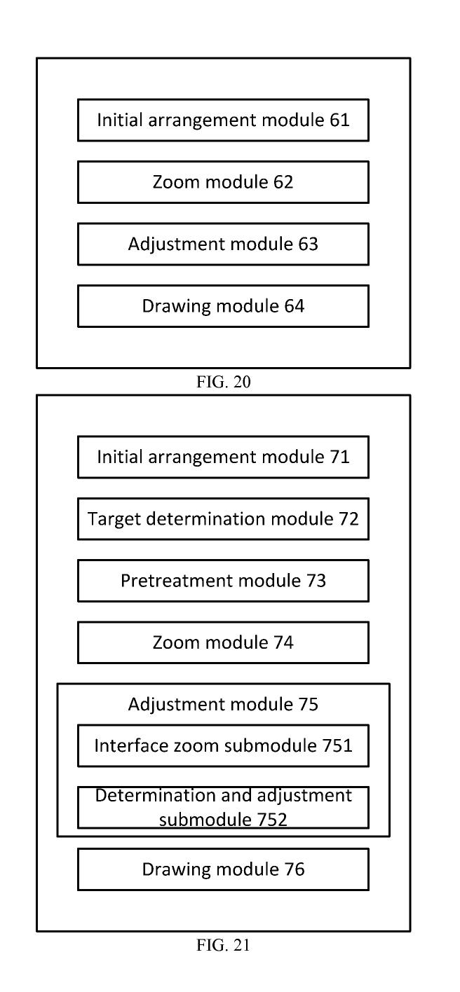

FIG. 20 is a structure diagram illustrating an apparatus of implementing screen adaptation for an owner-drawn element in accordance with an embodiment of the present invention. Referring to FIG. 20, an apparatus of implementing screen adaptation for owner-drawn elements proposed in this embodiment may be used to realize the method mentioned in such as the embodiment shown in FIG. 8. In an example, the apparatus includes: an initial arrangement module 61, a zoom module 62, an adjustment module 63, and a drawing module 64. In the embodiment, the adaptation interface of the first interface has the same size as the target screen, and the target determination module 52 may be omitted. In another example, the target determination module may be employed in FIG. 20 to designate the target screen as the adaptation interface of the first interface. The adjustment module 63 is to zoom the first interface according to the size of the target screen. Other modules are the same as corresponding modules in the embodiment shown in FIG. 19, which may not be described hereon.

FIG. 21 is a structure diagram illustrating an apparatus of implementing screen adaptation for an owner-drawn element in accordance with an embodiment of the present invention. Referring to FIG. 21, an apparatus of implementing screen adaptation for owner-drawn elements proposed in this embodiment may be used to realize the method mentioned in such as the embodiment shown in FIG. 11. In an example, the apparatus includes: an initial arrangement module 71, a target determination module 72, a pretreatment module 73, a zoom module 74, an adjustment module 75, and a drawing module 76.

The initial arrangement module 71 is to arrange at least one owner-drawn element according to a resolution of an initial screen, and obtain a first view adapted to the initial screen, wherein the first view includes a first interface and the at least one owner-drawn element arranged on the first interface. The target determination module 72 is to determine an adaptation interface of the first interface according to a resolution of a target screen. The pretreatment module 73 is to obtain an interface pretreatment proportion according to the resolution of the target screen and the resolution of the initial screen, and zoom the first interface and the at least one owner-drawn element of the first view according to the interface pretreatment proportion to get a second view, wherein the second view includes a second interface and owner-drawn elements arranged on the second interface. In an example, a smaller value among a ratio of the lateral resolution of the target screen to the lateral resolution of the initial screen and a ratio of the longitudinal resolution of the target screen to the longitudinal resolution of the initial screen is selected as the interface pretreatment proportion. The zoom module 74 is to define a corresponding container for each owner-drawn element arranged on the second interface, wherein the second interface is defined as a container of one of the at least one owner-drawn element arranged on the first interface, obtain at least one margin of each owner-drawn element relative to a corresponding container, and set the attribute of the at least one margin as a fixed margin or a zoomed margin, wherein the margin with the attribute of fixed margin is kept constant, and the margin with the attribute of zoomed margin changes with the zooming of the corresponding container. The adjustment module 75 is to zoom the second interface according to the size of the adaptation interface, and adjust the owner-drawn element arranged on the second interface according to the margin attributes of the owner-drawn element relative to its corresponding container, in order to obtain a third view. The drawing module 76 is to draw the third view on the target screen.

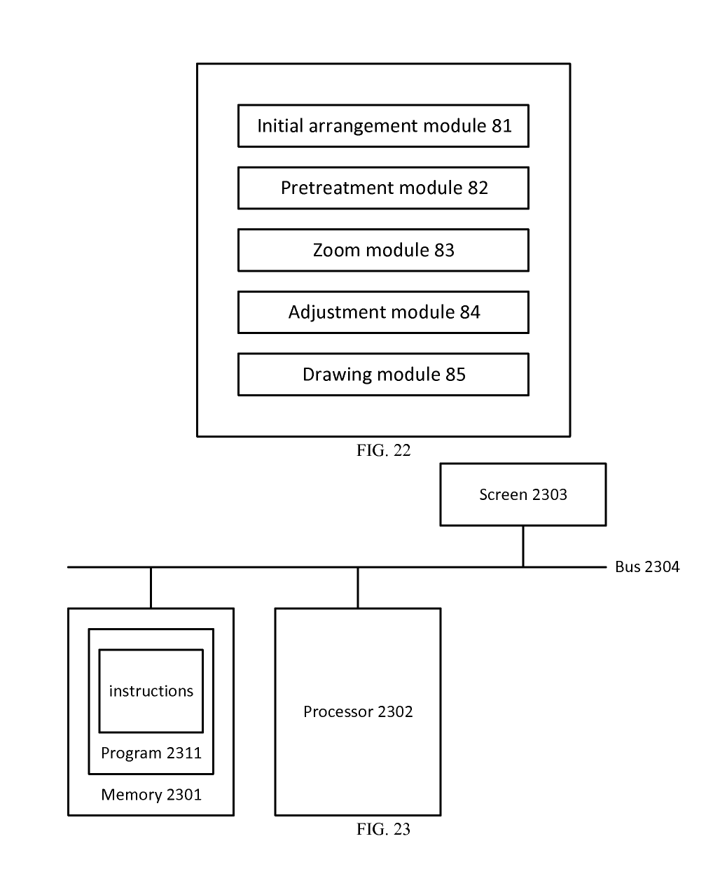

FIG. 22 is a structure diagram illustrating an apparatus of implementing screen adaptation for an owner-drawn element in accordance with an embodiment of the present invention. Referring to FIG. 22, an apparatus of implementing screen adaptation for owner-drawn elements proposed in this embodiment may be used to realize the method mentioned in such as the embodiment shown in FIG. 15. In an example, the apparatus includes: an initial arrangement module 81, a pretreatment module 82, a zoom module 83, an adjustment module 84, and a drawing module 85. In this embodiment, the adaptation interface of the first interface has the same size as the target screen, and the target determination module 72 may be omitted. In another example, the target determination module may be used in FIG. 22 to designate the target screen as the adaptation interface of the first interface. The adjustment module 84 is to zoom the second interface according to the size of the target screen. Other modules are the same as corresponding modules in the embodiment shown in FIG. 21, which may not be described hereon.

In an example, a computing device as illustrated in FIG. 23 is provided in the present invention, which includes: memory 2301, and one or more processors 2302. Specifically, one or more programs 2311 are stored in the memory 2301 and configured for execution by the one or more processors 2302. Further, the computing device may include a screen 2303 for displaying information such as an interface. Within the computing device, the memory 2301, the processor 2302, and other components are coupled together using bus 2304. Bus 2304 may include an electrical, optical, and/or electro-optical connection that the components can use to communicate commands and data among one another. Although only one bus 2304 is shown for clarity, different embodiments can include a different number or configuration of electrical, optical, and/or electro-optical connections between the components within the computing device.

The one or more programs 2311 include instructions to: arrange at least one owner-drawn element according to a resolution of an initial screen, and obtain a first view adapted to the initial screen, wherein the first view includes a first interface and the at least one owner-drawn element arranged on the first interface; determine an adaptation interface of the first interface according to a resolution of a target screen 2303; define a corresponding container for each owner-drawn element arranged on the first interface, wherein the first interface is defined as a container of one of the at least one owner-drawn element arranged on the first interface; obtain at least one margin of each owner-drawn element relative to a corresponding container, and set the attribute of the at least one margin as a fixed margin or a zoomed margin, wherein the margin with the attribute of fixed margin is kept constant, and the margin with the attribute of zoomed margin changes with the zooming of the corresponding container; zoom the first interface according to the size of the adaptation interface, and adjust the owner-drawn element arranged on the first interface according to the margin attributes of the owner-drawn element relative to its corresponding container, in order to obtain a second view; and draw the second view on the target screen 2303.

As described above, the present invention proposes a screen adaptation method for owner-drawn elements. In the method, an interface processing approach adopting interface zooming and elements arrangement adjusting is provided, which is simple and efficient. Also, the arrangement of various owner-drawn elements of the application software on the UI may be more coordinated and aesthetic.

In an example, for numerous complex interfaces of owner-drawn elements, there is no need to calculate the size and position of each owner-drawn element under different resolutions, separately. Accordingly, the difficulty and complexity of screen adaptation may be reduced, which may save large workload. In an example, the size and position of the owner-drawn element may simply be adjusted according to a proportion, which consumes less UI debug time. In an example, it is easy to satisfy the requirements on the size and position of multiple owner-drawn elements, such as aligning the owner-drawn elements, or placing an owner-drawn element in the center, without establishing a complicated relationship among the owner-drawn elements. Therefore, interface modification can be optimized.

It should be noted that various embodiments are described in an incremental manner. Each embodiment highlights the differences from other embodiments, and the identical or similar portions between various embodiments may not be described repeatedly. For embodiments regarding apparatus, due to their similarity to method embodiments, the associated description may refer to the method embodiments.

It should be noted that, as used herein, relational terms, such as first, second, and the like, merely refer to one entity or action distinguished from another entity or action, without necessarily requiring or implying any relationship or order between such entities or actions. Furthermore, the terms “comprise”, “include” or any other variation thereof are intended to cover a non-exclusive inclusion. In an example, a process, method, article, apparatus, or device does not include only those elements described, but also include other elements not expressly listed.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

The above examples may be implemented by hardware, software, firmware, or a combination thereof. For example the various methods, processes and functional modules described herein may be implemented by a processor (the term processor is to be interpreted broadly to include a CPU, processing unit/module, ASIC, logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof. The modules, if mentioned in the aforesaid examples, may be combined into one module or further divided into a plurality of sub-modules. Further, the examples disclosed herein may be implemented in the form of a software product. The computer software product is stored in a non-transitory storage medium/device and comprises a plurality of instructions for making an electronic device implement the method recited in the examples of the present disclosure. In an example, the storage medium may be a read-only memory (ROM), a magnetic disk or optical disk, etc.

What is claimed is:

1. A method of implementing screen adaptation for owner-drawn elements, comprising:
arranging at least one owner-drawn element according to a resolution of an initial screen, and obtaining a first view adapted to the initial screen, wherein the first view includes a first interface and the at least one owner-drawn element arranged on the first interface;
determining an adaptation interface of the first interface according to a resolution of a target screen;
defining a corresponding container for each owner-drawn element arranged on the first interface, wherein the first interface is defined as a container of one of the at least one owner-drawn element arranged on the first interface;
obtaining at least one margin of each owner-drawn element relative to a corresponding container, and setting the attribute of the at least one margin as a fixed margin or a zoomed margin, wherein the margin with the attribute of fixed margin is kept constant, and the margin with the attribute of zoomed margin changes with the zooming of the corresponding container;
zooming the first interface according to the size of the adaptation interface, and adjusting the owner-drawn element arranged on the first interface according to the margin attributes of the owner-drawn element relative to its corresponding container, in order to obtain a second view;
drawing the second view on the target screen.

2. The method of claim 1, wherein the adaptation interface has the same size as the target screen.

3. The method of claim 1, wherein adjusting the owner-drawn element arranged on the first interface according to the margin attributes of the owner-drawn element relative to its corresponding container comprises:
determining whether the owner-drawn element arranged on the first interface has a fixed margin attribute or zoomed margin attribute relative to its corresponding container; and
if the margin is the fixed margin, remaining the margin of the owner-drawn element relative to its container unchanged;
if the margin is the zoomed margin, zooming the margin of the owner-drawn element relative to its container in the same zoom ratio as the container at the direction of the margin.

4. A method of implementing screen adaptation for owner-drawn elements, comprising:
arranging at least one owner-drawn element according to a resolution of an initial screen, and obtaining a first view adapted to the initial screen, wherein the first view includes a first interface and the at least one owner-drawn element arranged on the first interface;
determining an adaptation interface of the first interface according to a resolution of a target screen;
obtaining an interface pretreatment proportion according to the resolution of the target screen and the resolution of the initial screen, and zooming the first interface and the at least one owner-drawn element of the first view according to the interface pretreatment proportion to get a second view, wherein the second view includes a second interface and owner-drawn elements arranged on the second interface;
defining a corresponding container for each owner-drawn element arranged on the second interface, wherein the second interface is defined as a container of one of the at least one owner-drawn element arranged on the first interface;
obtaining at least one margin of each owner-drawn element relative to a corresponding container, and setting the attribute of the at least one margin as a fixed margin or a zoomed margin, wherein the margin with the attribute of fixed margin is kept constant, and the margin with the attribute of zoomed margin changes with the zooming of the corresponding container;
zooming the second interface according to the size of the adaptation interface, and adjusting the owner-drawn element arranged on the second interface according to the margin attributes of the owner-drawn element relative to its corresponding container, in order to obtain a third view; and
drawing the third view on the target screen.

5. The method of claim 4, wherein a smaller value among a ratio of the lateral resolution of the target screen to the lateral resolution of the initial screen and a ratio of the longitudinal resolution of the target screen to the longitudinal resolution of the initial screen is selected as the interface pretreatment proportion.

6. The method of claim 4, wherein the adaptation interface has the same size as the target screen.

7. The method of claim 6, wherein adjusting the owner-drawn element arranged on the first interface according to the margin attributes of the owner-drawn element relative to its corresponding container comprises:
determining whether the owner-drawn element arranged on the second interface has a fixed margin attribute or zoomed margin attribute relative to its corresponding container; and
if the margin is the fixed margin, remaining the margin of the owner-drawn element relative to its container unchanged;
if the margin is the zoomed margin, zooming the margin of the owner-drawn element relative to its container in the same zoom ratio as the container at the direction of the margin.

8. A computing device, comprising:
memory;
one or more processors; and
one or more programs stored in the memory and configured for execution by the one or more processors, the one or more programs including instructions to:
arrange at least one owner-drawn element according to a resolution of an initial screen, and obtain a first view adapted to the initial screen, wherein the first view includes a first interface and the at least one owner-drawn element arranged on the first interface;
determine an adaptation interface of the first interface according to a resolution of a target screen;
define a corresponding container for each owner-drawn element arranged on the first interface, wherein the first interface is defined as a container of one of the at least one owner-drawn element arranged on the first interface;
obtain at least one margin of each owner-drawn element relative to a corresponding container, and set the attribute of the at least one margin as a fixed margin or a zoomed margin, wherein the margin with the attribute of fixed margin is kept constant, and the margin with the attribute of zoomed margin changes with the zooming of the corresponding container;
zoom the first interface according to the size of the adaptation interface, and adjust the owner-drawn element arranged on the first interface according to the margin attributes of the owner-drawn element relative to its corresponding container, in order to obtain a second view; and
draw the second view on the target screen.
